(19) United States
(12) Patent Application Publication
(10) Pub. No.: US 2017/0302373 A1
(43) Pub. Date: Oct. 19, 2017

(54) OPTICAL MODULE AND CONTROL METHOD FOR OPTICAL MODULE

(71) Applicant: FUJITSU LIMITED, Kawasaki-shi (JP)

(72) Inventors: Masahiro Yamakami, Fukuoka (JP); Chikara SHIBAGAKI, Fukuoka (JP); Jun Endoh, Fukuoka (JP); Akira Tokieda, Fukuoka (JP); Seiji Miyata, Kitakyusyuu (JP); Fusae Yamanouchi, Fukuoka (JP)

(73) Assignee: FUJITSU LIMITED, Kawasaki-shi (JP)

(21) Appl. No.: 15/482,007

(22) Filed: Apr. 7, 2017

(30) Foreign Application Priority Data
Apr. 14, 2016 (JP) 2016-081339

(51) Int. Cl. H04B 10/079; H04B 10/50; H04J 14/02

(52) U.S. Cl. CPC H04B 10/07955; H04B 10/5057; H04J 14/0221

(57) ABSTRACT

An optical module includes an optical modulator that performs optical modulation of transmission data, an optical modulator controller that controls the optical modulator, a memory that stores corresponding relationships between temperatures and set data with which modulation of the optical modulator is to be performed at an operating point voltage, a temperature sensor that measures a temperature in the optical module; and a setting circuit that refers the memory and searches for set data corresponding to measured temperature, and set the set data to the optical modulator controller.

### CROSS-REFERENCE TO RELATED APPLICATION

This application is based upon and claims the benefit of priority of the prior Japanese Patent Application No. 2016-081339, filed on Apr. 14, 2016, the entire contents of which are incorporated herein by reference.

### FIELD

The embodiment discussed herein is related to an optical module that performs an optical communication service through optical modulation operation and a control method for the optical module.

### BACKGROUND

A plurality of optical transmission apparatus are provided on an optical network (transmission line), for example, of the wavelength division multiplexing (WDM) type. Each optical transmission apparatus inserts or branches (Add/Drop) an optical signal corresponding to transmission/reception data of a user (subscriber) into or from the optical network.

An optical module provided in an optical transmission apparatus mutually converts an electric signal on the user side and an optical signal on the transmission line side. The optical modulating unit of the optical module first converts transmission data (electric signal) from a user into an optical signal and then performs optical modulation of multiplexing and placing the transmission data on the optical signal. Then, the optical modulating unit outputs the optical signal (transmission light) to the optical network side.

For the optical modulator, feedback control to normally obtain a fixed operating point voltage is performed, and the transmission light and the position of the operating point voltage are compared with each other. Along with this, if the operating point voltage (bias voltage) for the electric signal is set to a midpoint between a maximum point and a minimum point of the optical signal, a maximum value and a minimum value of the optical signal may be identified with certainty. If this operating point voltage is displaced from the midpoint of the optical signal, the reception side of the optical signal (different optical transmission apparatus) fails to demodulate the optical signal accurately.

If, within a period within which feedback control of the optical modulator is executed, an event that involves resetting of the control unit (central processing unit (CPU)), for example, resetting after control software is downloaded or the like occurs, the feedback control is rendered ineffective, and it is difficult to maintain a normal operating point voltage.

For example, there is a technology wherein an optimum bias point of an optical modulator is stored together with a temperature of the optical modulator when the optical bias point is determined and a control value of a bias point corresponding to a current temperature is read out from a table and used for bias control. Also there is another technology wherein, upon updating in service of a control unit (field programmable gate array (FPGA)) of an optical amplification apparatus, control of various parameters of excitation light and so forth is continued using control values retained in advance.

However, feedback control is performed only within a limited period within which a control unit may operate normally, and upon resetting of the control unit or in a like case, operation of the control unit including optical modulation stops and the optical communication service stops. Further, a control value read out during updating of the control unit (which corresponds to a period during resetting after downloading of software) is a fixed value and is not a control value ready for the temperature and so forth at the point of time (ready for the latest situation). Therefore, it is difficult to perform bias control with a high degree of accuracy. Further, if a temperature variation occurs during stopping of operation of the control unit, it is difficult to perform optimum operating point voltage control.

The followings are reference documents.

### [Document 1] Japanese National Publication of International Patent Application No. 2010-501908, and

### [Document 2] Japanese Laid-open Patent Publication No. 2007-220977

### SUMMARY

According to an aspect of the embodiment, an optical module includes: an optical modulator that performs optical modulation of transmission data; an optical modulator controller that controls the optical modulator; a memory that stores corresponding relationships between temperatures and set data with which modulation of the optical modulator is to be performed at an operating point voltage; a temperature sensor that measures a temperature in the optical module; and a setting circuit that refers the memory and searches for set data corresponding to measured temperature, and set the set data to the optical modulator controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an example of a configuration of an optical module according to an embodiment;

FIG. 2 is a chart illustrating an example of set contents of a set value table of an optical module according to the embodiment;

FIG. 3 is a diagram illustrating linear interpolation of set data of an optical module according to the embodiment;

FIG. 4 is a chart illustrating an operating point voltage in a normal state of an optical modulator of an optical module according to the embodiment;

FIG. 5 is a chart (part 1) illustrating an operating point voltage in an abnormal state of an optical modulator of an optical module according to the embodiment;

FIG. 6 is a chart (part 2) illustrating an operating point voltage in another abnormal state of an optical modulator of an optical module according to the embodiment;

FIGS. 7A and 7B are charts illustrating updating storage of set value tables of an optical module according to the embodiment;

FIG. 8 is a flow chart illustrating an example of operation of an optical module according to the embodiment; and

FIG. 9 is a block diagram depicting an example of a configuration of an optical transmission apparatus to which an optical module according to the embodiment is applied.

### DESCRIPTION OF EMBODIMENT

### Embodiment

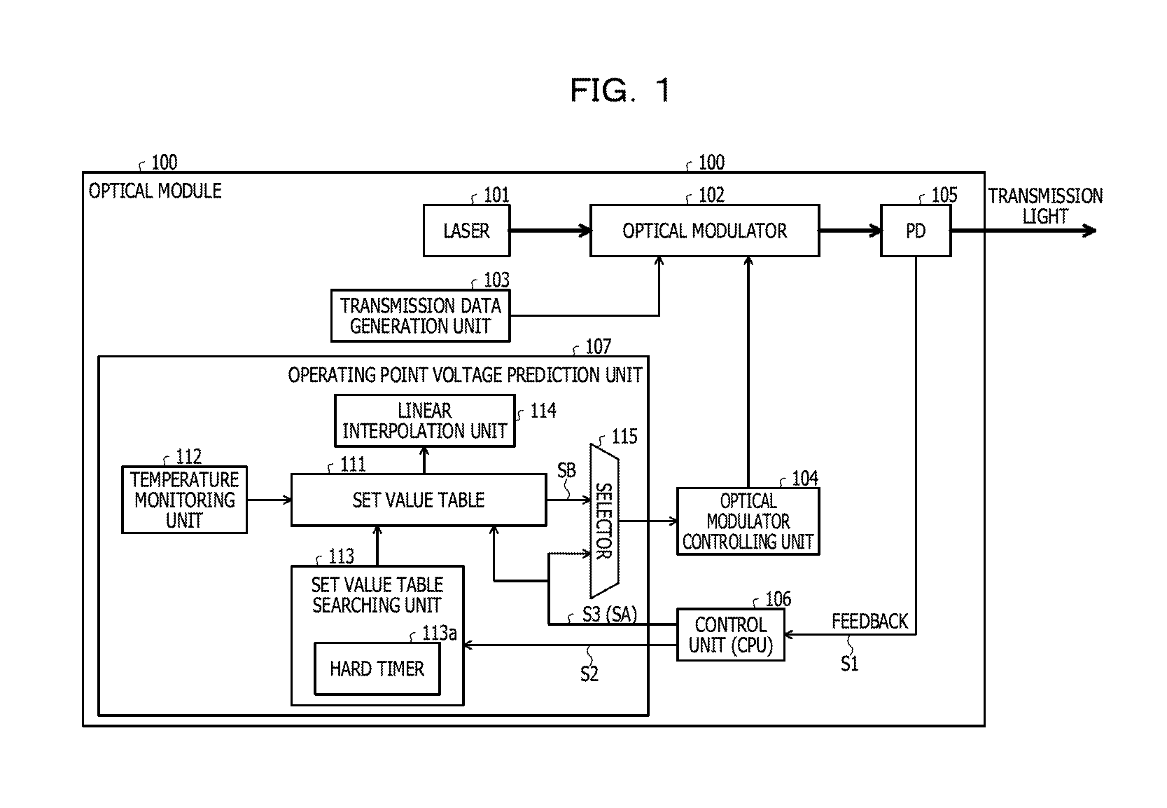

FIG. 1 is a block diagram depicting an example of a configuration of an optical module according to an embodiment. In FIG. 1 that depicts an optical module 100, principally a configuration on the transmission side from which an optical signal (transmission light) for insertion is outputted to an optical transmission apparatus on an optical network is depicted.

The optical module 100 includes an optical laser (Laser) 101, an optical modulator 102, a transmission data generation unit 103, an optical modulator controlling unit 104, a photo-detector (photodiode (PD)) 105, a control unit 106, and an operating point voltage prediction unit 107. The control unit 106 is configured from a processor that executes a program such as a CPU.

To the optical modulator 102, an optical signal emitted from the optical laser 101 and transmission data (electric signal) of a user outputted from the transmission data generation unit 103 are inputted. The optical modulator 102 performs optical modulation of placing the transmission data on the optical signal under the control of the optical modulator controlling unit 104 and outputs the optically modulated transmission data as transmission light.

The photo-detector 105 detects an optical power of the transmission light and outputs the detected optical power as feedback information S1 to the control unit 106. The control unit 106 is responsible for control of the entire optical module 100. Further, the control unit 106 compares the optical power of the transmission light detected by the photo-detector 105 with a position of the operating point voltage and sets, if a displacement is detected between them, a value for returning the operating point voltage to a normal position to the optical modulator controlling unit 104. The control unit 106 repeats such comparison and setting as just described after every fixed cycle (for example, three milliseconds). This suppresses variation of the operating point voltage of the optical modulator 102 caused by a temperature or a time-dependent degradation.

In the embodiment, a control signal of the control unit 106 is outputted to the optical modulator controlling unit 104 through the operating point voltage prediction unit 107. The control unit 106 performs control of the operating point voltage (bias voltage) as the CPU of the control unit 106 executes a control program stored in a read-only memory (ROM) or the like (not depicted) and a random access memory (RAM) or the like is used as a work area.

The control unit 106 is inoperable in regard to the operating point voltage during a period of resetting by an updating process or the like of the control program (software). That the control unit 106 is inoperable in the embodiment has the same meaning as that the control unit 106 is uncontrollable and signifies that the control unit 106 is temporarily disabled to perform control of the operating point voltage (incontrollable, inoperable) but is not in failure.

The operating point voltage prediction unit 107 is configured from a hardware circuit (electric circuit element) such as a flip-flop (FF) and performs control of the operating point voltage in place of the control unit 106 within a period within which the control unit 106 is inoperable in regard to the operating point voltage.

The operating point voltage prediction unit 107 includes a set value table 111, a temperature monitoring unit (temperature sensor) 112, a set value table searching unit 113, a linear interpolation unit 114, and a selector 115.

The set value table 111 retains correspondences of set data for setting an operating point voltage for the optical modulator 102 and a temperature in the form of a table. The set value table 111 may be formed using a rewritable memory (for example, a RAM or the like).

As the set data of the set value table 111, set data are normally generated (updated and stored) by the control unit 106 during an operating period of the control unit 106. On the other hand, within a period within which the control unit 106 is inoperable, the set value table searching unit 113 reads out the set value retained in the set value table 111.

The temperature monitoring unit 112 detects a current temperature that is normally varying and may be formed, for example, using a temperature sensor. The temperature monitoring unit 112 individually detects a temperature upon writing of set data into the set value table 111 and a temperature upon reading out of set data from the set value table 111.

The set value table searching unit 113 is activated and starts operation based on a trigger S2 outputted from the control unit 106 before the control unit 106 is rendered inoperable (for example, upon starting of a resetting process), and refers to the set value table 111 and searches for set data corresponding to a temperature detected by the temperature monitoring unit 112.

The set value table searching unit 113 includes a hard timer 113a, by which the set value table 111 is searched after every fixed cycle. The cycle of search based on the hard timer 113a is same as the interval after which the control unit 106 acquires feedback information S1 from the photo-detector 105.

The linear interpolation unit 114 approximates (interpolates) and outputs set data corresponding to the detected temperature when, upon reading out of set data from the set value table 111, set data of the temperature detected by the temperature monitoring unit 112 is not found.

The selector 115 changes over the reading out path for set data outputted from the set value table 111 to output the set data to the optical modulator controlling unit 104. Here, the control unit 106 outputs, in an ordinary operation, a control signal S3 to cause the set value table 111 to execute generation (updating and storing) of set data. In accordance with the control signal S3, the selector 115 changes over the path such that set data SA of an operating point voltage (bias voltage) outputted from the control unit 106 is outputted to the optical modulator 102.

On the other hand, within a period within which the control unit 106 is inoperable, the selector 115 changes over the path such that set data SB outputted from the set value table 111 is outputted to the optical modulator 102.

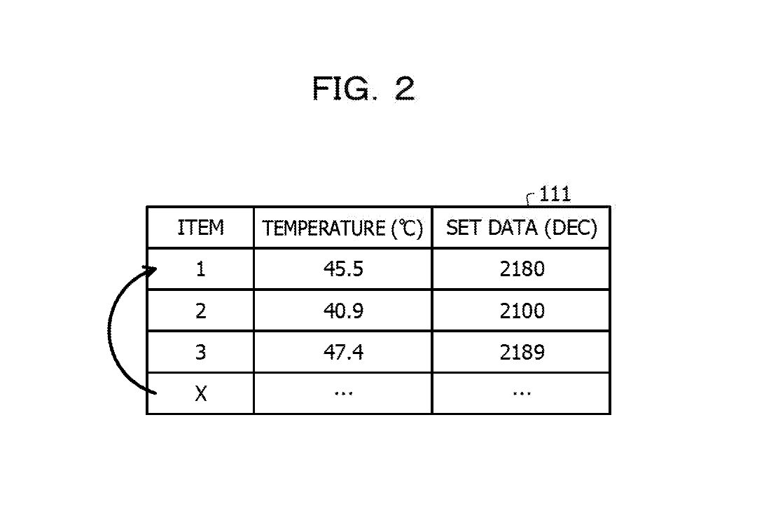

FIG. 2 is a chart illustrating an example of set contents of a set value table of an optical module according to the embodiment. The control unit 106 successively stores, in an ordinary operation, a temperature detected by the temperature monitoring unit 112 after every fixed cycle and set data SA of a calculated operating point voltage (bias voltage) into the set value table 111. The set data is a voltage value of an operating point voltage.

The control unit 106 successively stores a fixed number X of set data into the set value table 111 and successively overwrites, after the number X is reached, the first set data with new set data. The set data stored in the set value table 111 are read out by the operating point voltage prediction unit 107 that operates during a period within which the control unit 106 is inoperable, as described above.

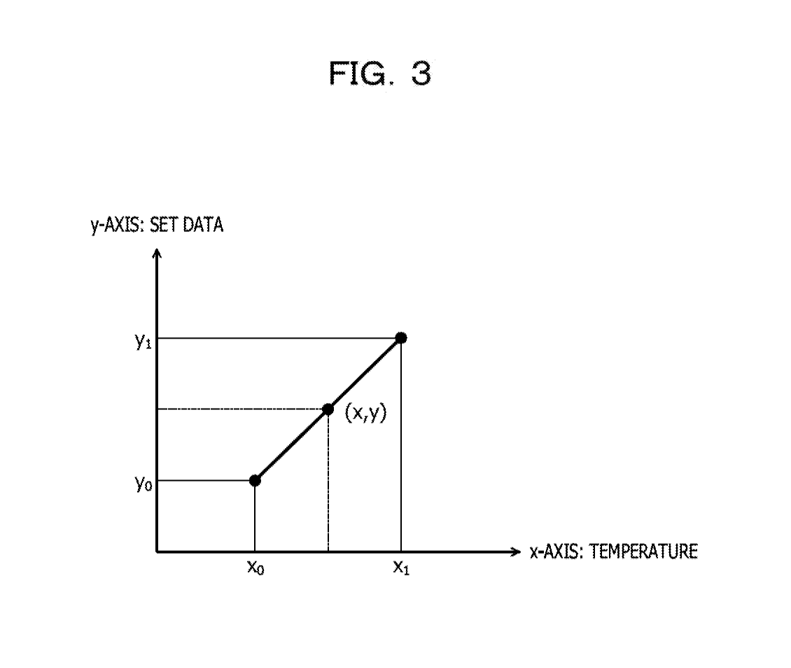

FIG. 3 is a diagram illustrating linear interpolation of set data of an optical module according to the embodiment. The linear interpolation unit 114 operates during a period within which the control unit 106 is inoperable and performs, when set data corresponding to the temperature detected by the temperature monitoring unit 112 is not found in the set value table 111, an approximation (linear interpolation) process of set data for the temperature.

In FIG. 3, the axis of abscissa indicates the temperature and the axis of ordinate indicates set data. An example of linear interpolation in which two pieces of set data stored in the set value table 111 are used is described with reference to FIG. 3. It is assumed that the temperature detected by the temperature monitoring unit 112 is, for example, 46.1° C. In the example of FIG. 2, this temperature (46.1° C.) is not stored. In this case, the linear interpolation unit 114 reads out set data (2180 at 45.5° C. and 2189 at 47.4° C.) corresponding to two higher and lower temperatures across the temperature of the set data to be determined.

x₀=45.5, x₁=47.4, x=46.1

y₀ and y₁ are set as y₀=2180 and y₁=2189, and an approximate value for the current temperature x=46.1 is determined in accordance with y=y₀+(y₁+y₀)·(x−x₀)/(x₁−x₀). As a result, the set data corresponding to 46.1° C. may be determined as 2182 (truncated after decimal point).

The linear interpolation unit 114 may perform an interpolation process in which data of two points are used as described above or may further perform an interpolation process in which an additional number of data are used. As the number of data is increased, the accuracy may be increased.

(Operating Point Voltage)

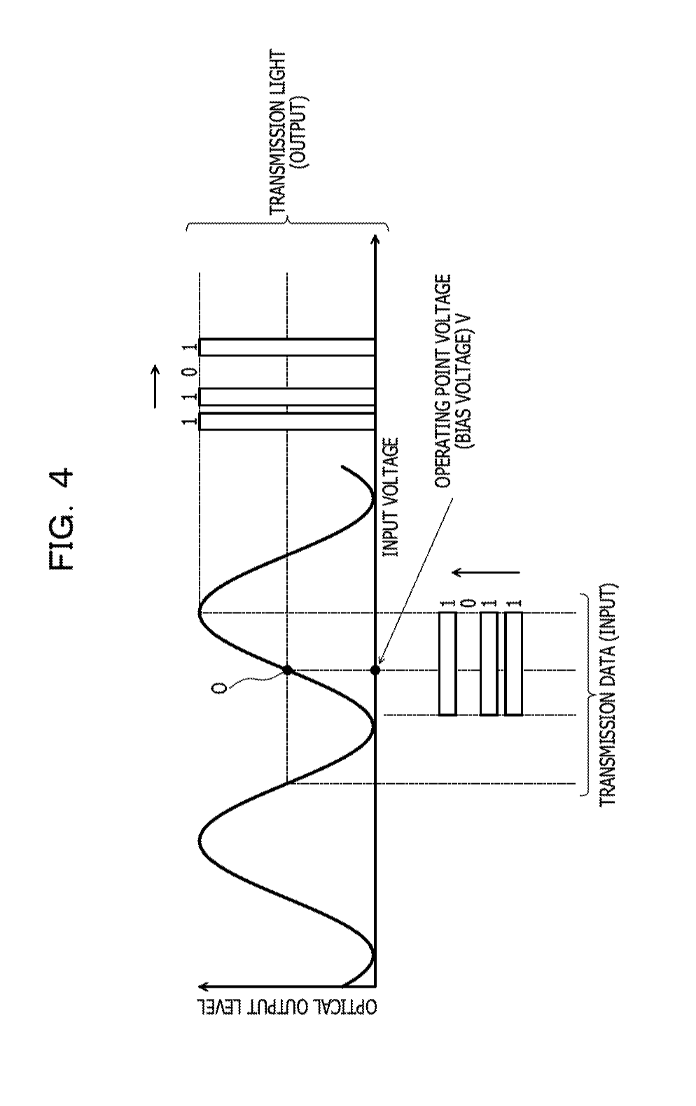

FIG. 4 is a chart illustrating an operating point voltage in a normal state of an optical modulator of an optical module according to the embodiment. In FIG. 4, the axis of abscissa indicates an input voltage of transmission data, and the axis of ordinate indicates an output level of transmission light outputted from the optical module (optical modulator).

The control unit 106 sets an operating point voltage (bias voltage) V of an electric signal to a midpoint O between a maximum point and a minimum point of modulated transmission light. Consequently, the control unit 106 may output transmission data “bit string 1011 . . . ” inputted as they are as transmission light “bit string 1011 . . . ” Consequently, both of the maximum value “bit 1” and the minimum value “bit 0” of the transmission light upon reception on the reception side (different optical transmission apparatus) may be identified accurately.

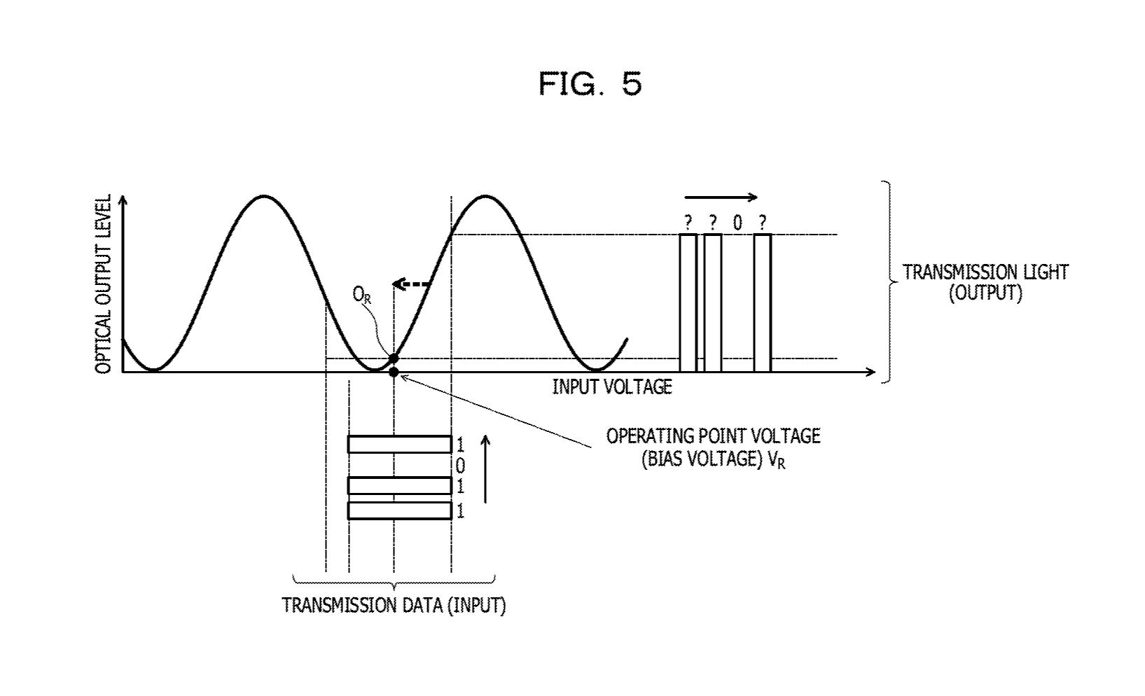

FIG. 5 is a chart illustrating an operating point voltage in an abnormal state of an optical modulator of an optical module according to the embodiment. FIG. 5 illustrates a state in which transmission light is displaced as a whole to the right (in a direction later in time) in comparison with FIG. 4. In this case, an operating point voltage V_{R} is set corresponding not to the midpoint O between a maximum point and a minimum point of transmission light but to a position O_{R} in the proximity of the minimum value of the optical signal. Consequently, transmission data “bit string 1011 . . . ” inputted are outputted as transmission light “bit string ?0?? . . . (? represents that the bit is indefinite between 0 and 1).” In the case of the example of FIG. 5, it is difficult to accurately identify the maximum value “bit 1.”

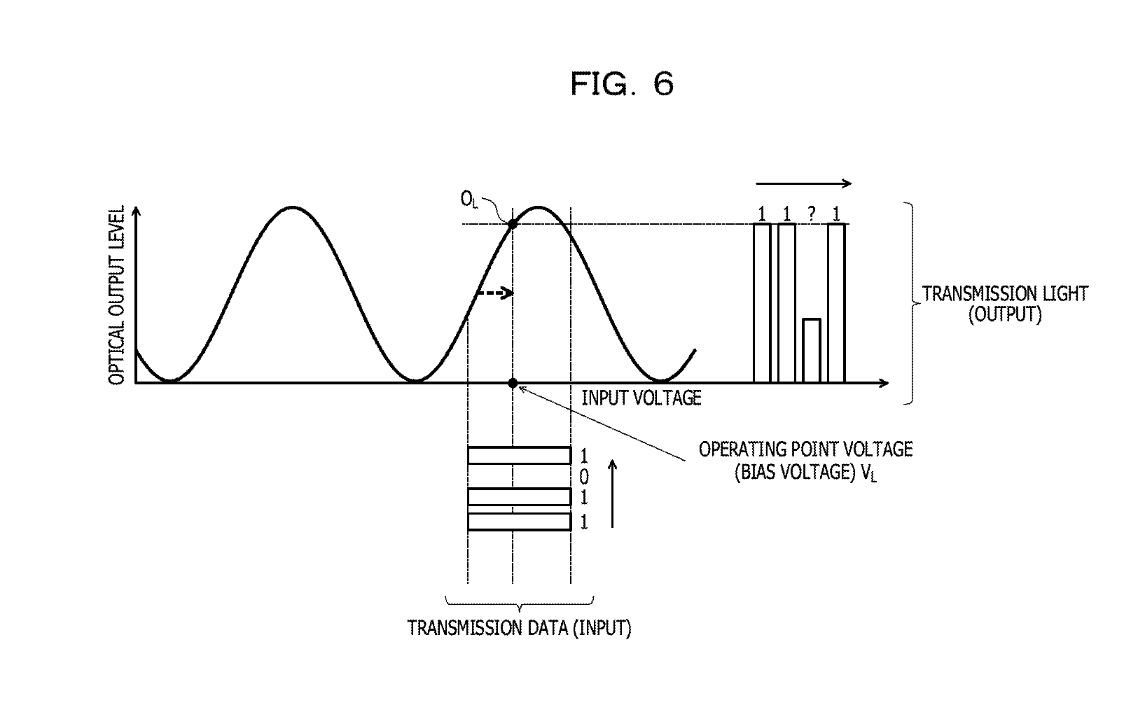

FIG. 6 is a chart illustrating an operating point voltage in another abnormal state of an optical modulator of an optical module according to the embodiment. FIG. 6 illustrates a state in which transmission light is displaced as a whole to the left (in a direction earlier in time) in comparison with FIG. 4. In this case, an operating point voltage V_{L} is set corresponding not to the midpoint O between a maximum point and a minimum point of transmission light but to a position O_{L} in the proximity of the minimum value of the optical signal. Consequently, transmission data “bit string 1011 . . . ” inputted are outputted as transmission light “bit string 1?11 . . . .” In the case of the example of FIG. 6, it is difficult to accurately identify the minimum value “bit 0.”

When it is difficult to accurately set the operating point voltage to a midpoint O between a maximum point and a minimum point from some factor such as the temperature, transmission light to be outputted is converted incompletely in amplitude, and it is sometimes difficult to accurately identify the transmission light when it is received by the reception side (different optical transmission apparatus).

(Example of Writing Process into Set Value Table)

The control unit 106 performs the following processes in its ordinary operation.

(1) The control unit 106 acquires feedback information 51 from the photo-detector 105.

(2) The control unit 106 calculates set data to be set to the optical modulator 102 based on the feedback information 51 of the photo-detector 105.

(3) The control unit 106 outputs the calculated set data to the optical modulator controlling unit 104 through the selector 115 to cause the optical modulator controlling unit 104 to set the set data to the optical modulator 102.

(4) Simultaneously with the process (3) above, the control unit 106 stores the calculated set data into the set value table 111. Simultaneously, the control unit 106 reads out a temperature upon storage from the temperature monitoring unit 112 and stores the temperature into the set value table 111 (for example, 45.5° C. and set data 2180 in item 1 depicted in FIG. 2).

(5) The control unit 106 repeats the processes (1) to (4) described above in a fixed cycle. (The storage location of next set data becomes item 2 in FIG. 2).

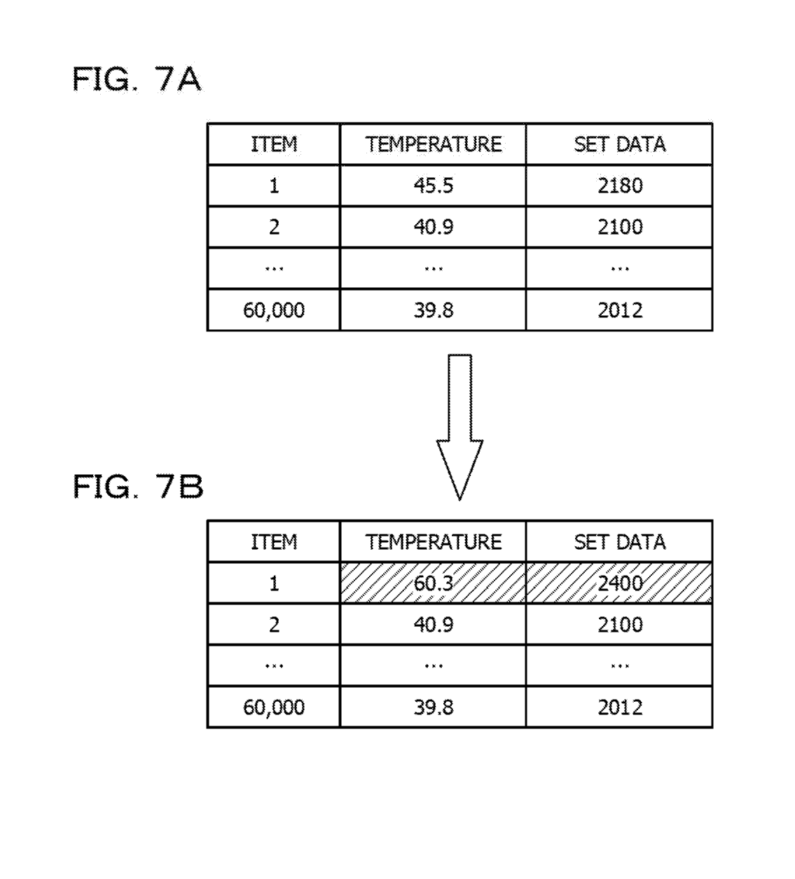

FIGS. 7A and 7B are charts illustrating updating storage of set value tables of an optical module according to the embodiment. As depicted in FIG. 7A, set data are successively stored into item 1, item 2, item 3, . . . , and item X in the set value table 111. After set data are stored up to the last item (item 60000) of the set value table 111, next set data is overwritten into the location of top item 1 as depicted in FIG. 7B.

By updating and storing set data using the set value table 111 cyclically in this manner, the storage region (number of the items X) to be used as the set value table 111 may be suppressed to a fixed value. Further, the set value table 111 may be normally ready for the latest temperature variation, and therefore, control with a high degree of accuracy may be anticipated.

Where the reset recovery time is three minutes and the fixed cycle time is three milliseconds, the storage area (capacity) for the set value table 111 may be set to a capacity with which an information amount corresponding to 60,000 cycles or more may be assured. For example, where the number X of set data to be retained by the set value table 111 is 60000 and the data amount of a temperature for one data and set data is 4 bytes, the set value table 111 may have a storage capacity of approximately 240 kilobytes.

(Example of Reading Out Process from Set Value Table)

When the control unit 106 is inoperable, the operating point voltage prediction unit 107 (set value table searching unit 113) performs the following processes.

(1) If the control unit 106 is rendered inoperative, the set value table searching unit 113 searches the set value table 111 using a temperature detected by the temperature monitoring unit 112 as a current temperature. If the detected temperature is, for example, 47.4° C., the set data may be specified as 2189 (refer to FIG. 2).

(2) The set data searched out is outputted to the optical modulator controlling unit 104 through the selector 115. The optical modulator controlling unit 104 sets the set data to the optical modulator 102.

(3) If set data corresponding to the temperature detected by the temperature monitoring unit 112 is not found in the set value table 111, the set value table searching unit 113 outputs set data interpolated by the linear interpolation unit 114 to the optical modulator controlling unit 104 through the selector 115. The optical modulator controlling unit 104 sets the set data to the optical modulator 102.

(4) The processes (1) to (3) described above are repeated in a fixed cycle using the hard timer 113a provided in the set value table searching unit 113 (for example, in a cycle same as the cycle of the control unit 106).

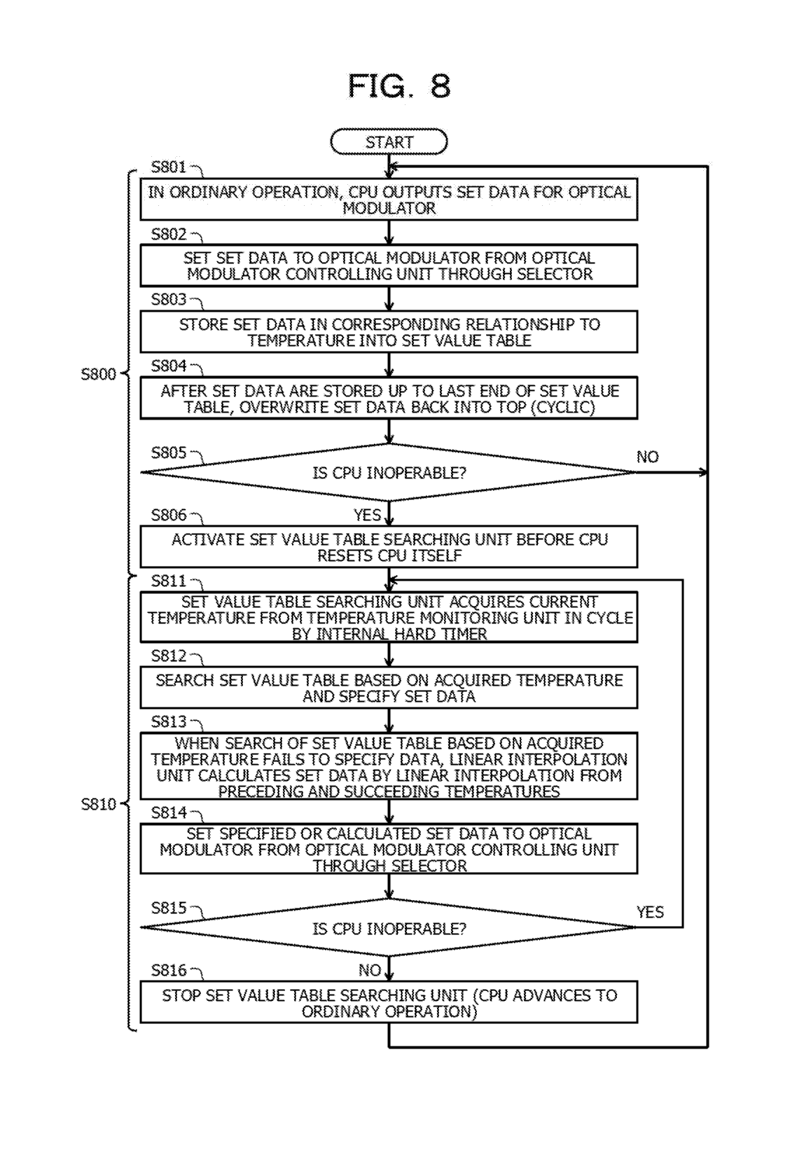

FIG. 8 is a flow chart illustrating an example of operation of an optical module according to the embodiment. An example of operation of the respective components of the optical module 100 described above, principally of the control unit 106 and the operating point voltage prediction unit 107, is described. Referring to FIG. 8, the range of step S800 indicates processes performed by the control unit 106 when the control unit 106 operates normally, and the range of step S810 indicates processes performed by the operating point voltage prediction unit 107 activated when the control unit 106 is inoperable.

First, in an ordinary operation, the control unit (CPU) 106 calculates set data for the optical modulator 102 in a fixed cycle based on the feedback information S1 of the photo-detector 105 and outputs the set data in the fixed cycle (step S801). The control unit 106 outputs the calculated set data to the optical modulator controlling unit 104 through the selector 115 such that the set data is set from the optical modulator controlling unit 104 to the optical modulator 102 (step S802).

The control unit 106 stores the set data together with a temperature detected by the temperature monitoring unit 112 into the set value table 111 (step S803). It is to be noted that, if set data are stored up to the last end of the set value table 111, the control unit 106 overwrites the subsequently calculated set data back into the top address of the set value table 111 (step S804).

Thereafter, the control unit 106 decides whether or not the control unit 106 itself is in an inoperable state (step S805). For example, the control unit 106 decides whether or not a resetting event after downloading of controlling software occurs.

Then, if a result of the decision indicates that no resetting occurs and the control unit 106 may continue ordinary operation (step S805: No), the control unit 106 returns the process to step S801 to repeat the processes at steps S801 to S804 in a next cycle.

On the other hand, if a result of the decision indicates that resetting based on downloading of controlling software or the like occurs (step S805: Yes), the control unit 106 activates the operating point voltage prediction unit 107 (set value table searching unit 113) before the control unit 106 resets itself (step S806).

Later processes are executed by the activated operating point voltage prediction unit 107 (set value table searching unit 113), and the control unit 106 may perform resetting and a re-driving process of the control unit 106 itself in parallel to the operation of the operating point voltage prediction unit 107.

The activated set value table searching unit 113 acquires a current temperature from the temperature monitoring unit 112 in a cycle by the internal hard timer 113a (step S811). Then, the set value table searching unit 113 searches the set value table 111 based on the acquired temperature to specify set data corresponding to the temperature (step S812).

In this case, if the search for set data corresponding to the temperature fails to specify set data corresponding to the temperature detected by the temperature monitoring unit 112, the set value table searching unit 113 calculates set data by linear interpolation of the linear interpolation unit 114 (step S813). This liner interpolation may be calculated using set data at temperatures preceding to and following the detected temperature (refer to FIG. 3).

Thereafter, the set value table searching unit 113 outputs the set data specified at step S812 or set data obtained by the liner interpolation at step S813 to the optical modulator controlling unit 104 through the selector 115. The optical modulator controlling unit 104 sets the set data (bias voltage) to the optical modulator 102 (step S814)

Thereafter, the set value table searching unit 113 decides whether or not the control unit 106 remains in an inoperable state (step S815). Then, if a result of the decision indicates that the control unit 106 is within a reset period (for example, in a re-activation state) (step S815: Yes), the process returns to step S811 to continue the operation of the set value table searching unit 113. While the operation continues, the set value table searching unit 113 repeats the processes at steps S811 to S815.

On the other hand, if a result of the decision indicates that resetting (re-activation or the like) of the control unit 106 is completed and the control unit 106 is in a normally operable state (step S815: No), the set value table searching unit 113 stops its operation (step S816). Then, since the control unit 106 is in a normally operable state, the process advances to step S801.

Consequently, the processes at step S801 and the succeeding steps by the control unit 106 after resetting may be performed continuously.

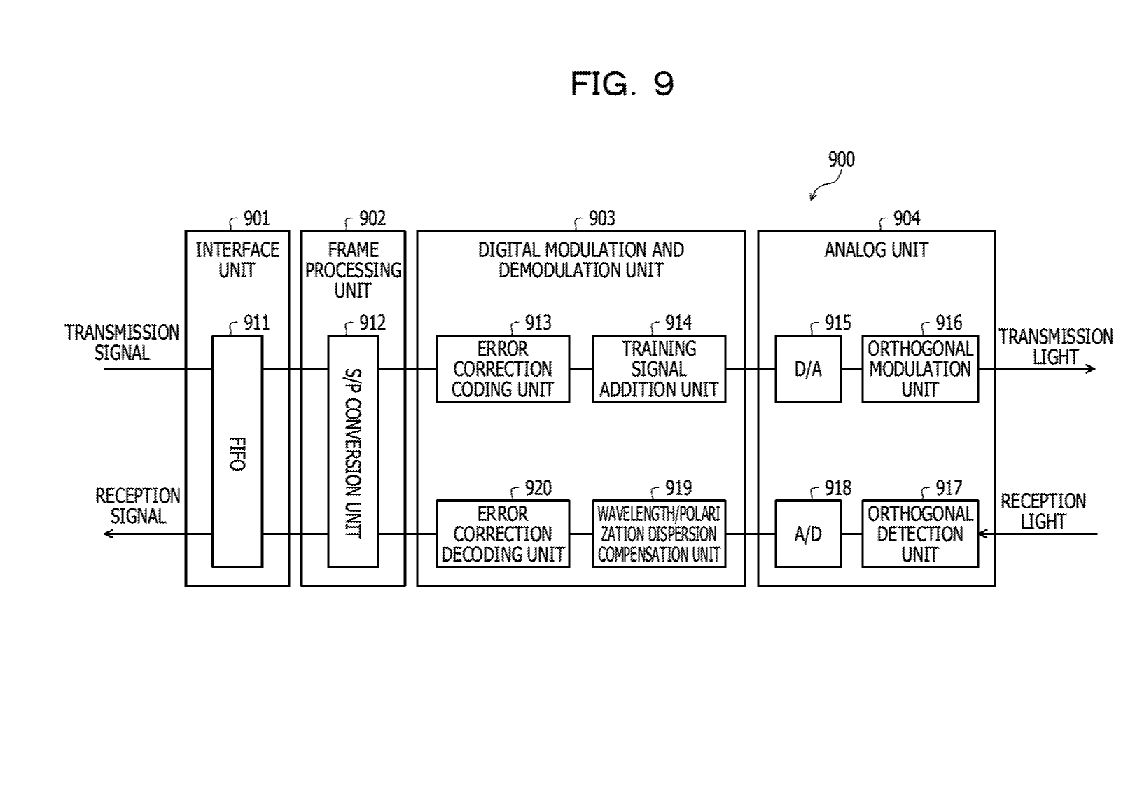

FIG. 9 is a block diagram depicting an example of a configuration of an optical transmission apparatus to which an optical module according to the embodiment is applied. FIG. 9 principally depicts a configuration for signal conversion between an electric signal and an optical signal from within an optical transmission apparatus 900 provided on a WDM network.

The optical transmission apparatus 900 includes an interface unit 901, a frame processing unit 902, a digital modulation and demodulation unit 903, and an analog unit 904. The interface unit 901 inputs and outputs transmission/reception data (electric signal) for a user. Such transmission/reception data are controlled for data storage and takeout using a memory (first in first out (FIFO)) 911.

In the frame processing unit 902, a serial/parallel (S/P) conversion unit 912 performs serial/parallel conversion of transmission/reception data to perform frame processing. The digital modulation and demodulation unit 903 includes, for the transmission data side, an error correction coding unit 913 for error correction of transmission data and a training signal addition unit 914 for adding a training signal to the transmission data. For the reception data side, the digital modulation and demodulation unit 903 includes a wavelength/polarization dispersion compensation unit 919 for compensating for a wavelength and a polarization dispersion of reception data received through a transmission line, and an error correction decoding unit 920 for performing error correction and decoding of the reception data.

The analog unit 904 includes, on the transmission data side, a digital-to-analog (D/A) converter 915 for converting digitally inputted transmission data into analog data, and an orthogonal modulation unit 916 for orthogonally modulating the transmission data and outputting a multiplexed optical signal (transmission light) to the transmission line side. On the reception data side, the analog unit 904 includes an orthogonal detection unit 917 for orthogonally detecting an optical signal (reception light) from the transmission line side, and an analog-to-digital (A/D) converter 918 for digitally converting the analog reception data after the detection.

In the orthogonal modulation unit 916 of FIG. 9, the optical module 100 described hereinabove (refer to FIG. 1) is provided and performs control of the operating point voltage of the optical modulator 102 for optically modulating transmission data.

With the embodiment described above, the control unit that controls the optical modulator updates and stores set data during an ordinary operation of the control unit. However, within a period within which the control unit is inoperable, the operating point prediction unit is activated and may continuously control the optical modulator using the stored and retained set data. Consequently, an optical communication service may be continued without stopping.

Further, the control unit stores, when the control unit operates normally, correspondences between set data and temperatures into a table after every given cycle, and within a period within which the CPU is inoperable, the operating point prediction unit reads out the set data of an operating point voltage from the table using a temperature detected in a cycle same as the cycle in an ordinary operation as a search key. Where the cycle for reading out of set data of the operating point prediction unit is made same as the writing cycle of set data by the control unit in this manner, also within a period within which the control unit is inoperable, control of the operating point voltage may be performed with a degree of accuracy same as that by the control unit. For example, even if a variation in temperature arises within a period within which the control unit is not operative, optimum operating point voltage control may be performed.

Further, even in a case in which a table search performed using a temperature as a search key while the operating point prediction unit is operative indicates that set data corresponding to the temperature is not found, set data is calculated by linear interpolation based on the set data at the preceding and succeeding temperatures. Consequently, degradation in accuracy in control of the operating point voltage within a period within which the control unit is inoperable may be suppressed.

From the foregoing, according to the embodiment, also within a period within which the control unit is inoperable, the optical modulator may be controlled continuously with a degree of accuracy same as that when the control unit operates normally, and also the operating point voltage may be controlled with a high degree of accuracy. Consequently, even within a period within which the control unit is inoperable upon resetting of the control unit involved in updating of controlling software or in a like case, an optical communication service may be continued without stopping. Consequently, maintenance of an entire system such as an optical transmission apparatus may be facilitated, and reduction in labor for a countermeasure against a case in which the control unit is inoperable may be anticipated.

It is to be noted that the control method described in the description of the present embodiment may be implemented by executing a control program prepared in advance by a computer (processor such as a CPU) of a target apparatus (the optical module described above or the like). The control program is recorded on a computer-readable recording medium such as a magnetic disk, an optical disk, or a universal serial bus (USB) flash memory, read out from the recording medium by a computer, and executed by the computer. Alternatively, the control program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical module comprising:
an optical modulator that performs optical modulation of transmission data;
an optical modulator controller that controls the optical modulator;
a memory that stores corresponding relationships between temperatures and set data with which modulation of the optical modulator is to be performed at an operating point voltage;
a temperature sensor that measures a temperature in the optical module; and
a setting circuit that refers the memory and searches for set data corresponding to measured temperature, and set the set data to the optical modulator controller.

2. The optical module according to claim 1, further comprising:
a photo-detector that detects an optical power of a transmission light of the optical modulator; and
a processor that compares the optical power of the transmission light with a position of the operating point voltage and calculates, if a displacement is detected between them, a value for returning the operating point voltage to a normal position, and outputs the value to the optical modulator controller.

3. The optical module according to claim 2, wherein
the processor stores the value as set data with the measured temperature.

4. The optical module according to claim 3, wherein
the setting circuit reads out the set data from the memory in a cycle same as the given cycle for the set data when the processor writes into the memory.

5. The optical module according to claim 3, wherein
the processor cyclically performs a writing process of a fixed number of the set data into the memory.

6. The optical module according to claim 1, wherein
the setting circuit performs, when the set data for a temperature coincident with the detected temperature is not stored in the memory, an interpolation arithmetic operation of set data corresponding to the detected temperature using set data at a plurality of temperatures in a proximity of the detected temperature stored in the memory.

7. The optical module according to claim 2, wherein
The processor stops a process when the program is to be updated.

8. The optical module according to claim 1, wherein
the setting circuit stops operation based on re-starting of the process of the processor.

9. The optical module according to claim 1, wherein
the optical module is incorporated in an optical network of a wavelength division multiplexing type so as to operate as part of an optical transmission apparatus that inserts or branches an optical signal.

10. The optical module according to claim 1, wherein
the set data is a bias voltage for driving the optical modulator.

11. A control method for an optical module including
an optical modulator that performs optical modulation of transmission data, an optical modulator controller that controls the optical modulator, and a memory that stores corresponding relationships between temperatures and set data with which modulation of the optical modulator is to be performed at an operating point voltage, the control method comprising:
detecting an optical power of a transmission light of the optical modulator; and
comparing the optical power of the transmission light with a position of the operating point voltage and calculating, if a displacement is detected between them, a value for returning the operating point voltage to a normal position;
measuring a temperature in the optical module;
setting the value to the optical modulator controller and storing the value as set data with the measured temperature;
when the setting is not executed, reading out the set data corresponding to a temperature from the memory; and
setting the read out set data to the optical modulator controller.
